(19) United States
(12) Patent Application Publication
(10) Pub. No.: US 2022/0323878 A1
(43) Pub. Date: Oct. 13, 2022

(54) COMBINED SOLAR AND WIND POWERED SPINNER

(71) Applicant: Yeiser Research & Development LLC, Santee, CA (US)

(72) Inventor: John O. Yeiser, IV, Santee, CA (US)

(21) Appl. No.: 17/715,893

(22) Filed: Apr. 7, 2022

Related U.S. Application Data
(60) Provisional application No. 63/171,920, filed on Apr. 7, 2021.

(51) Int. Cl. A63H 33/40; F03D 9/00; F16D 41/02; F03D 1/00

(52) U.S. Cl. CPC A63H 33/40; F03D 9/007; F16D 41/02; F03D 1/00; A01M 29/06

(57) ABSTRACT

A decorative wind spinner includes a blade assembly with blades radially emanating from a base configured to rotate around a rotational axis. The blades are driven by wind power at a rotational speed. A motor, powered by a photovoltaic panel, drives a rotating drive shaft. A one-way clutch links the drive shaft to the base so that when the rotational speed of the blade assembly is greater than the rotational speed of the drive shaft, the clutch prevents transfer of the rotational force from the drive shaft to the base. When the rotational speed of the blade assembly is less than the rotational speed of the drive shaft, the clutch transfers rotational force from the drive shaft to the base.

### RELATED APPLICATIONS

This application claims the benefit of the priority of U.S. provisional application No. 63/171,920, filed Apr. 7, 2021, which is incorporated herein by reference in its entirety.

### FIELD OF THE INVENTION

The present invention is a decorative spinner that may be activated by wind, solar power, or a combination thereof. Solar power will enable the wind spinner to turn in areas, or times of the day, where there is not enough wind.

### BACKGROUND

Wind spinners are popular yard décor that can be placed in an outdoor setting to add interesting color and action to a person's surroundings. They may also be used to discourage birds and small animals from lingering in garden areas where fruit and vegetables are grown. When the wind is blowing, the spinners work well, but on calm days when there is little wind, the spinner sits motionless, making it less visually interesting as well as failing to provide the desired deterrent effect.

### BRIEF SUMMARY

The inventive wind spinner overcomes the problems of calm days by adding a solar-powered motor. A clutch located on the motor drive shaft allows the blades to rotate freely in the wind. When the wind dies down, a solar panel kicks in to provide power and keep the spinner going. According to embodiments of the invention, the wind spinner may alternately be activated by either wind or solar power. A rechargeable battery may optionally be included to provide power to drive the motor when there is insufficient light or wind to drive the rotation. Solar power will enable the wind spinner to turn in areas, or times of the day, where there is not enough wind. The wind spinner can have two or more blades that are shaped and positioned to be propelled by the wind.

The blades all connect to a central unifying cartridge that houses an overrunning clutch which provides linkage to a drive shaft. The shaft is turned by a motor which receives electrical power generated by a solar panel triggered by adequate sunlight or artificial light.

When there is adequate sunlight the motor will turn the blades. Wind can also turn the blades simultaneously, but if the wind strength increases and surpasses the speed of the motor, the overrunning clutch will bypass the turning speed of the motor. This prevents stress on the motor. The clutch will also allow the blades to freely turn the opposite direction in the event of strong winds turning it in the unfavored direction.

The motor and its housing can be modular and detachable from the pole body.

The pole body can be collapsible and can be made of different materials such as metal, wood, or polymers.

The base can be a spike or prong formed of metal, polymer or a composite material to be inserted into the ground. Alternatively, the base can be a weighted block or plate formed of wood, or cement, with sufficient mass for stability, a spring or screw clamp, or a flange with two or more bores near the perimeter to allow it to be secured to a flat surface such as a deck or railing using screws or other fasteners.

In one aspect, the inventive wind spinner includes a support structure; a blade assembly comprising blades radially emanating from a base, the base configured to rotate around a rotational axis relative to the support structure, wherein the blades are configured to be driven by wind power at a first rotational speed; a motor having a rotating drive shaft at a second rotational speed; a photovoltaic (PV) panel configured to generate electrical energy for driving the motor when sufficient light is present; and a one-way clutch linking the drive shaft to the base, wherein when the first rotational speed is greater than the second rotational speed, the clutch is configured to prevent transfer of the rotational force from the drive shaft to the base, and when the first rotational speed is less than the second rotational speed, the clutch is configured to transfer rotational force from the drive shaft to the base. In some embodiments, when the drive shaft rotates in a drive shaft rotational direction, the clutch is further configured to prevent transfer of rotational force from the drive shaft when a rotational direction of the blade assembly is opposite to the drive shaft rotational direction. The second rotational speed is substantially continuous when sufficient light is present. The blades comprise two or more blades uniformly distributed around the base.

The wind spinner may further include a rechargeable battery connected to the PV panel configured to collect and store energy therefrom, wherein the battery is connected to the motor to provide stored energy to the motor. In some embodiments, the support structure supports a plurality of blade assemblies, motors, PV panels and clutches.

In another aspect, the inventive a wind spinner includes a support structure and one or more blade/drive assembly, where each blade/drive assembly includes a plurality of blades radially emanating from a base, the base configured to rotate around a rotational axis relative to the support structure, wherein the blades are configured to be driven by wind power at a first rotational speed;

a motor having a rotating drive shaft at a second rotational speed; a photovoltaic (PV) panel configured to generate electrical energy for driving the motor when sufficient light is present; and a one-way clutch linking the drive shaft to the base, wherein when the first rotational speed is greater than the second rotational speed, the clutch is configured to prevent transfer of the rotational force from the drive shaft to the base, and when the first rotational speed is less than the second rotational speed, the clutch is configured to transfer rotational force from the drive shaft to the base. The drive shaft rotates in a drive shaft rotational direction, so that the clutch is configured to prevent transfer of rotational force from the drive shaft when a rotational direction of the blades is opposite to the drive shaft rotational direction. The second rotational speed is substantially continuous when sufficient light is present. The blades may be two or more blades uniformly distributed around the base. The wind spinner may include a rechargeable battery connected to the PV panel configured to collect and store energy therefrom, where the battery is connected to the motor to provide stored energy to the motor. The support structure may support a plurality of blade/drive assemblies.

### BRIEF DESCRIPTION OF THE DRAWINGS

FIG. 1 is a perspective view of an embodiment of the inventive spinner.

FIG. 2 is a front view of an embodiment of the inventive spinner.

FIG. 3 is a top view of an embodiment of the inventive spinner.

FIG. 4 is a bottom view of an embodiment of the inventive spinner.

FIG. 5 is an exploded perspective front view of the upper portion of the inventive spinner.

FIG. 6 is an exploded perspective back view of the upper portion of the inventive spinner.

FIG. 7 is an exploded side view of the upper portion of an embodiment of the inventive spinner.

### DETAILED DESCRIPTION OF EMBODIMENTS

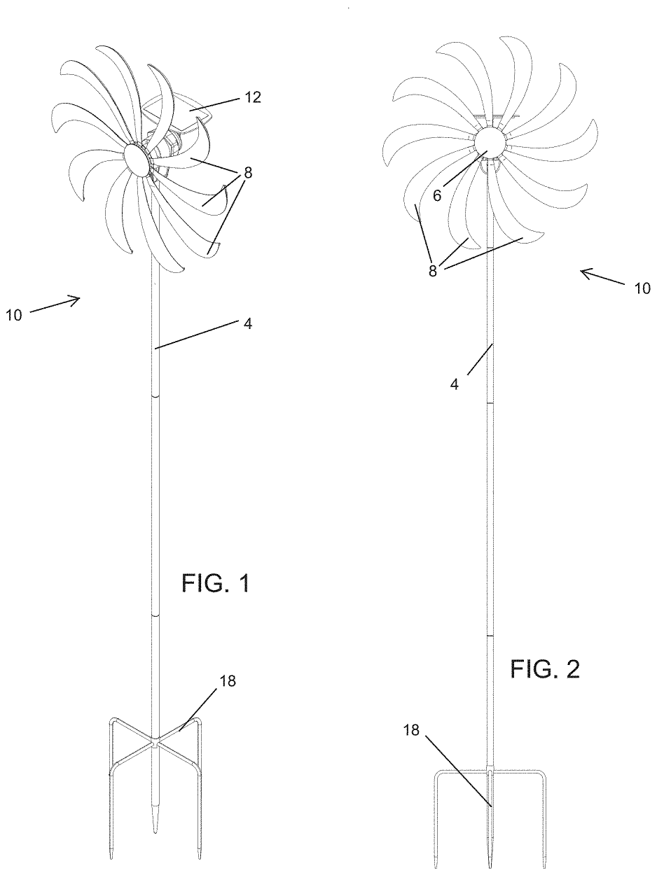

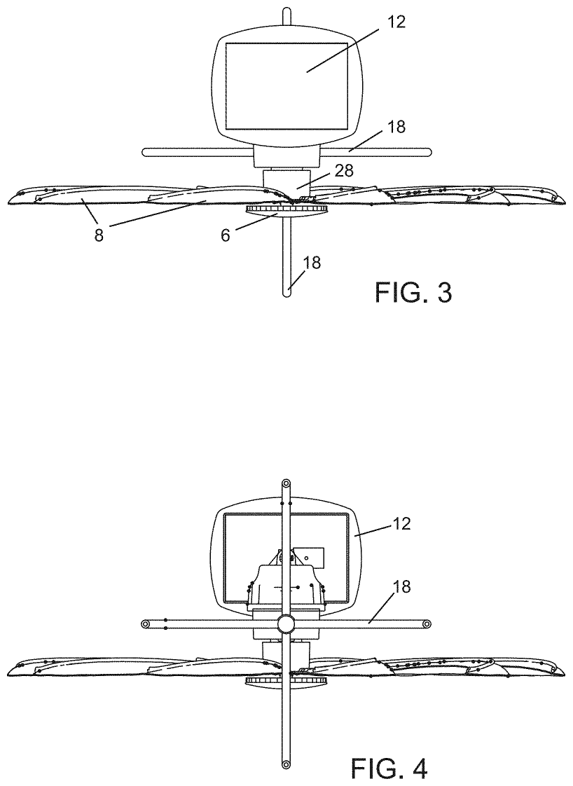

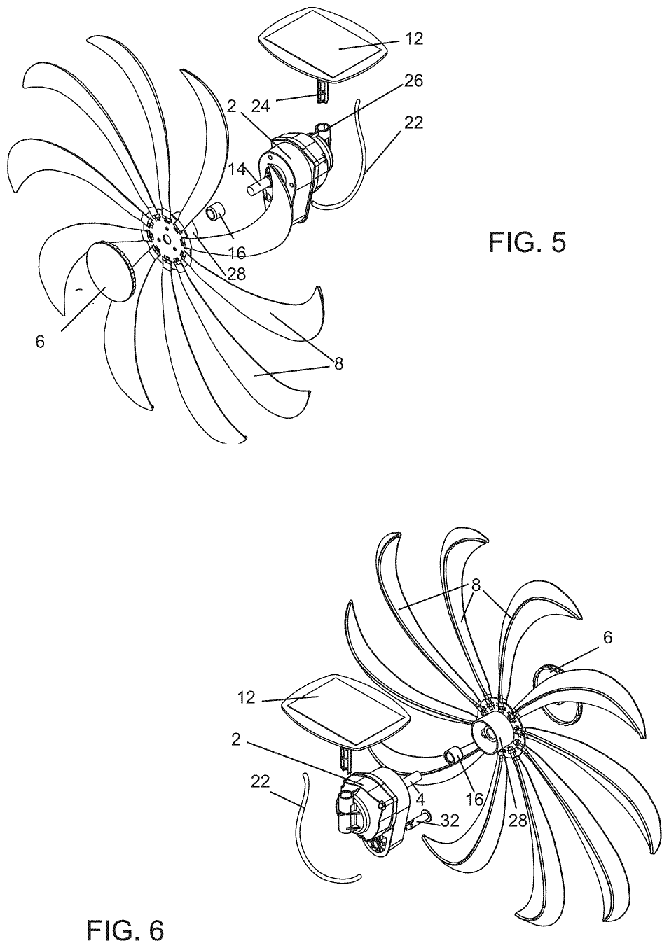

Referring to FIGS. 1-7, the inventive wind spinner is constructed to be activated by either wind or solar power. Solar power will enable the wind spinner to turn in areas, or times of the day, where there is not enough wind to drive the rotation of the blades. The wind spinner 10 may have two or more blades 8 that extend radially from center base 28. The blades are aerodynamically shaped and positioned to be propelled by the wind. As shown in the figures, the sample spinning structure has ten curved blades 8, giving it the appearance of a stylized flower. As will be readily apparent to those in the art, different blade numbers, combinations, and configurations may be used.

Center base 28 is a generally hollow cylindrical shape that may, in some embodiments, be integrally formed, e.g., molded, with the blades 8. Alternatively, the blades can be attached via adhesive, welding, rivets, or other appropriate fasteners to the base in a uniform distribution to ensure balanced rotation around the rotational axis. Drive shaft 14 is inserted through an opening at the center of base 28 and is held in place by cap 6, affixed by a screw fitting, interference fit, or other appropriate attachment means. The interior of base 28 houses a one-way bearing clutch 16 that provides a linkage between the interior of base 28, i.e., the “driven shaft”, and drive shaft 14. As is known in the art, the one-way bearing clutch 16, also known as an “overrunning clutch” or a “freewheel clutch”, allows rotation in one direction only, preventing force from being driven in the opposite direction. The one-way clutch is a key functional component of the inventive spinner, the purpose of which is to transmit torque in only one rotational direction while preventing transmission of torque in the opposite rotational direction. The clutch 16 allows the center base 28 to spin freely when driven by wind power without the drive shaft 14 controlling it. The shaft 14 is rotated by motor 2 which receives electrical power generated by a photovoltaic panel 12. The light for powering panel 12 may come from sunlight or artificial light.

When there is adequate sunlight but no wind, motor 2 will rotate the blade assembly. In some embodiments, the motor 2 will operate at a fixed maximum rotational speed, however, the speed may vary depending on the voltage generated by the panel 12. Motor 2 runs continuously as long as power is supplied. Wind may also turn the blades simultaneously, but if the wind strength increases and surpasses the maximum speed of the motor, the overrunning clutch 16 will bypass the rotational speed of the motor. When the driven shaft of base 28 is rotating faster than the drive shaft 14, the clutch 16 mechanically disconnects the driveshaft from the base 28. This will prevent any stress on the motor. The clutch 16 will also allow the blade assembly (base 28 and blades 8) blades to freely rotate in the opposite direction in the event of strong winds turning it in the unfavored direction.

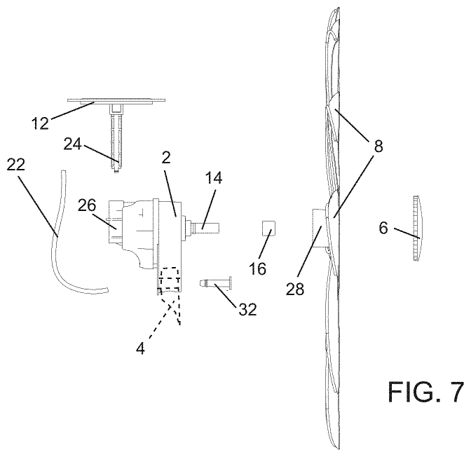

In the exemplary embodiment, assembly of the solar panel 12 to the motor 2 is achieved by inserting a boss 24 into a corresponding receptacle 26 formed in the motor housing. A wire 22 conducts electrical power generated by the panel 12 to motor 2. The motor 2 and its housing can be modular and detachable from the pole body 18 as shown in FIG. 7. A bore formed in the lower portion of the motor housing is dimensioned for insertion of an upper end of pole body 4, illustrated with dashed lines. Once inserted into the bore, locking pin 32 is inserted through openings in the housing and the upper end of pole body 4 to retain the two parts together.

In some embodiments, the pole can be formed in sections from an appropriate material such as metal, wood, polymer, or composite material. The horizontal lines cutting across the pole body 4 as shown in FIGS. 1 and 2 represent the sections of the pole that can be fit together, e.g., via interference fit or mating screws, to assemble a pole of the desired height. The lower end of pole body 9 may have a spike for insertion into the ground. In the embodiments shown in FIGS. 1 & 2, at the lower end of pole body 4, a pronged structure 18 can extend radially from the center for providing additional stability when inserted into the ground. Alternatively, the lower end of pole body can be inserted into a weighted block or plate formed of wood, or cement, with sufficient mass for stability. As will be readily apparent to those in the art, other options for stable mounting can include a spring or screw clamp, or a flange with two or more bores near the perimeter to allow it to be secured to a flat surface such as a deck or railing using screws or other fasteners.

A wind spinner assembly may include multiple blade assemblies mounted on a single support structure. For example, a single pole body may have branches or arms each supporting a motor and blade assembly. Each blade assembly will include a clutch linkage to provide solar power to rotate the blade assembly when needed. Further, the support structure may involve more than one pole body extending from a single base, with each pole body supporting one or more blade assemblies, motors, and solar panels. In some embodiments, the wind spinner may be part of a whirligig or an animated or kinetic sculpture, in which case the support structure may not be a simple pole, but will be part of the sculpture construction.

While the example wind spinner shown in the figures has a rotational axis that is substantially parallel to the ground (or other mounting surface), it will be readily apparent to those in the art that the rotational axis can be at a non-parallel position relative to the ground, e.g., angled up or down. When multiple blade assemblies are mounted on a support structure, the blade assemblies may be configured to turn in the same direction or in opposing directions.

In some embodiments, a rechargeable battery may be added to the assembly to be charged by wind motion, the solar panel, or a combination thereof. Appropriate circuitry for operation of such an assembly may include light sensors or timers for switching the battery power on or off. Such circuitry is well known to those in the art. Additionally, low power lighting such as LEDs may be added to the assembly to be turned on by light sensors or timers in the evening.

1. A wind spinner, comprising:
a support structure;
a blade assembly comprising blades radially emanating from a base, the base configured to rotate around a rotational axis relative to the support structure, wherein the blades are configured to be driven by wind power at a first rotational speed;
a motor having a rotating drive shaft at a second rotational speed;
a photovoltaic (PV) panel configured to generate electrical energy for driving the motor when sufficient light is present; and
a one-way clutch linking the drive shaft to the base, wherein when the first rotational speed is greater than the second rotational speed, the clutch is configured to prevent transfer of the rotational force from the drive shaft to the base, and when the first rotational speed is less than the second rotational speed, the clutch is configured to transfer rotational force from the drive shaft to the base.

2. The wind spinner of claim 1, wherein the drive shaft rotates in a drive shaft rotational direction, and wherein the clutch is further configured to prevent transfer of rotational force from the drive shaft when a rotational direction of the blade assembly is opposite to the drive shaft rotational direction.

3. The wind spinner of claim 1, wherein the second rotational speed is substantially continuous when sufficient light is present.

4. The wind spinner of claim 1, wherein the blades comprise two or more blades uniformly distributed around the base.

5. The wind spinner of claim 1, further comprising a rechargeable battery connected to the PV panel configured to collect and store energy therefrom, wherein the battery is connected to the motor to provide stored energy to the motor.

6. The wind spinner of claim 1, wherein the support structure supports a plurality of blade assemblies, motors, PV panels and clutches.

7. A wind spinner, comprising:
a support structure; and
one or more blade/drive assembly, each blade/drive assembly comprising:
a plurality of blades radially emanating from a base, the base configured to rotate around a rotational axis relative to the support structure, wherein the blades are configured to be driven by wind power at a first rotational speed;
a motor having a rotating drive shaft at a second rotational speed;
a photovoltaic (PV) panel configured to generate electrical energy for driving the motor when sufficient light is present; and
a one-way clutch linking the drive shaft to the base, wherein when the first rotational speed is greater than the second rotational speed, the clutch is configured to prevent transfer of the rotational force from the drive shaft to the base, and when the first rotational speed is less than the second rotational speed, the clutch is configured to transfer rotational force from the drive shaft to the base.

8. The wind spinner of claim 1, wherein the drive shaft rotates in a drive shaft rotational direction, and wherein the clutch is further configured to prevent transfer of rotational force from the drive shaft when a rotational direction of the blades is opposite to the drive shaft rotational direction.

9. The wind spinner of claim 7, wherein the second rotational speed is substantially continuous when sufficient light is present.

10. The wind spinner of claim 7, wherein the blades comprise two or more blades uniformly distributed around the base.

11. The wind spinner of claim 7, further comprising a rechargeable battery connected to the PV panel configured to collect and store energy therefrom, wherein the battery is connected to the motor to provide stored energy to the motor.

12. The wind spinner of claim 7, wherein the support structure supports a plurality of blade/drive assemblies.
